(19) United States
(12) Patent Application Publication
(10) Pub. No.: US 2024/0281103 A1
(43) Pub. Date: Aug. 22, 2024

(54) INTERACTION METHOD AND APPARATUS BASED ON MULTIMEDIA CONTENT, AND DEVICE AND STORAGE MEDIUM

(71) Applicant: Beijing Zitiao Network Technology Co., Ltd., Haidian District, Beijing (CN)

(72) Inventors: Ye GAO, Beijing (CN); Yinan JIA, Beijing (CN)

(21) Appl. No.: 18/572,056

(22) PCT Filed: Jun. 21, 2022
(86) PCT No.: PCT/CN2022/100000

§ 371 Date: Dec. 19, 2023

(30) Foreign Application Priority Data
Jun. 21, 2021 (CN) 202110687974.1

(51) Int. Cl. G06F 3/0481; G06F 3/0484; G06F 3/16

(52) U.S. Cl. CPC G06F 3/0481; G06F 3/0484; G06F 3/165

(57) ABSTRACT

Provided in the present disclosure are an interaction method and apparatus based on a multimedia content, and a device and a storage medium. The method includes: when a preset interaction operation, which is triggered by a first user for a first multimedia content, is received, firstly, acquiring feedback information corresponding to the first multimedia content, and then, displaying the feedback information, wherein the feedback information can indicate that the creator of the first multimedia content obtains a virtual object on the basis of the preset interaction operation.

### CROSS REFERENCES TO RELATED APPLICATIONS

This application claims the priority of China's patent application filed in China National Intellectual Property Administration on Jun. 21, 2021, with an application No. 202110687974.1 and an invention name of “INTERACTION METHOD, DEVICE AND EQUIPMENT BASED ON MULTIMEDIA WORKS AND STORAGE MEDIUM”, the entire content of which is incorporated into this application by reference.

### TECHNICAL FIELD

The application relates to the field of data processing, and in particular, relates to an interaction method, apparatus, device and storage medium based on multimedia works.

### BACKGROUND

With the rapid development of multimedia technology, there are an increasing number of interaction modes based on multimedia works.

To meet users' demands for diversified interaction modes based on multimedia works, how to continuously enrich interaction modes based on multimedia works is an urgent technical problem to be solved at present.

### SUMMARY

In order to solve or at least partially solve the above technical problems, embodiments

of the present disclosure provide an interaction method, apparatus, device and storage medium based on multimedia works.

In a first aspect, an embodiment of the present disclosure provides an interaction method based on multimedia works, which comprises the following steps:
obtaining feedback information corresponding to a first multimedia work in response to a preset interaction operation triggered for the first multimedia work; wherein the feedback information is used to indicate that a first user obtains a virtual object based on the preset interaction operation, and the first user is a creator of the first multimedia work; and
displaying the feedback information corresponding to the first multimedia work.

In an alternative embodiment, the displaying the feedback information corresponding to the first multimedia work includes the following step:
displaying the feedback information corresponding to the first multimedia work on a pop-up window.

In an alternative embodiment, the method further comprises the following steps:
obtaining feedback effect data corresponding to the first multimedia work in response to the preset interaction operation triggered for the first multimedia work; wherein the feedback effect data includes at least one of audio effect data, video effect data and animation effect data; and
playing the feedback effect data.

In an alternative embodiment, the first multimedia work is a video work or a music work, and the playing the feedback effect data comprises the following steps:
determining playback volume of the feedback effect data based on current volume of the first multimedia work; wherein the playback volume is greater than the current volume of the first multimedia work; and
playing the feedback effect data based on the playback volume.

In an alternative embodiment, the method further comprises the following step:
configuring feedback effect data corresponding to a second multimedia work in response to a first configuration triggering operation for the second multimedia work; wherein the feedback effect data is used to be played when the preset interaction operation is triggered for the second multimedia work.

In an alternative embodiment, the configuring the feedback effect data corresponding to the second multimedia work in response to the first configuration triggering operation for the second multimedia work comprises the following steps:
displaying a first feedback configuration page in response to the first configuration triggering operation for the second multimedia work, wherein a recording control and/or an uploading control are arranged on the first feedback configuration page; and
recording or uploading audio data or video data as the feedback effect data corresponding to the second multimedia work in response to the triggering operation for the recording control or the uploading control, or uploading an animation as the feedback effect data corresponding to the second multimedia work.

In an alternative embodiment, the method further comprises the following step:
configuring feedback effect data corresponding to a second user in response to a second configuration triggering operation; wherein the feedback effect data is used to be played when the preset interaction operation is triggered for a third multimedia work with the second user as a creator.

In an alternative embodiment, the configuring the feedback effect data corresponding to the second user in response to the second configuration triggering operation comprises the following steps:
displaying a second feedback configuration page in response to the second configuration triggering operation, wherein a recording control and/or an uploading control are arranged on the second feedback configuration page; and
recording or uploading audio data or video data as the feedback effect data corresponding to the second user in response to the triggering operation for the recording control or the uploading control, or uploading an animation as the feedback effect data corresponding to the second user.

In an alternative embodiment, the method further comprises the following step:
deleting or modifying the feedback effect data in response to a deleting operation or a modifying operation for the configured feedback effect data.

In an alternative embodiment, the method further comprises:
receiving a notification message for the second multimedia work; wherein, the notification message is used for instructing the third user to trigger the preset interaction operation for the second multimedia work.

In an alternative embodiment, the method further comprises the following step:
receiving a notification message for the third multimedia work; wherein, the notification message is used for instructing a third user to trigger the preset interaction operation for the third multimedia work.

In an alternative embodiment, after the configuration of the feedback effect data is completed, it further comprises the following steps:
playing a fourth multimedia work on a preview page; and
playing the feedback effect data on the preview page in response to the preset interaction operation triggered for the fourth multimedia work.

In a second aspect, an embodiment of the present disclosure provides an interaction apparatus based on multimedia works, comprising:
a first obtaining module, configured to obtain feedback information corresponding to a first multimedia work in response to a preset interaction operation triggered for the first video multimedia work; wherein the feedback information is used to indicate that a first user obtains a virtual object based on the preset interaction operation, and the first user is a creator of the first multimedia work; and
a first displaying module, configured to display the feedback information corresponding to the first multimedia work.

In a third aspect, an embodiment of the present disclosure provides a computer-readable storage medium, having stored therein instructions, which, when executed on a terminal device, the terminal device is enabled to realize the above method.

In a fourth aspect, an embodiment of the present disclosure provides a device including: a memory, a processor, and a computer program stored in the memory and executable on the processor, and when the processor executes the computer program, the above method is realized.

In a fifth aspect, an embodiment of the present disclosure provides a computer program product comprising computer programs/instructions which, when executed by a processor, realize the above method.

### BRIEF DESCRIPTION OF THE DRAWINGS

The accompanying drawings, which are incorporated in and constitute a part of this specification, illustrate embodiments consistent with the disclosure and, together with the description, serve to explain principles of the disclosure.

To explain the technical scheme in the embodiment of the present disclosure or related technology more clearly, the drawings needed in the description of the embodiment or related technology will be briefly introduced below. Obviously, for ordinary people in the field, other drawings can be obtained according to these drawings without paying creative labor.

FIG. 1 is a flowchart of an interaction method based on multimedia works provided by an embodiment of the present disclosure;

FIG. 2 is a schematic diagram of a playing page of a first multimedia work provided by an embodiment of the present disclosure;

FIG. 3 is a schematic diagram of a pop-up window provided by an embodiment of the present disclosure;

FIG. 4 is a schematic diagram of another playing page of a first multimedia work provided by an embodiment of the present disclosure;

FIG. 5 is a schematic diagram of a first feedback configuration page provided by an embodiment of the present disclosure;

FIG. 6 is a schematic diagram of a second feedback configuration page provided by an embodiment of the present disclosure;

FIG. 7 is a schematic diagram of a preview page provided by an embodiment of the present disclosure;

FIG. 8 is a schematic structural diagram of an interaction apparatus based on multimedia works provided by an embodiment of the present disclosure; and

FIG. 9 is a schematic structural diagram of an interaction apparatus based on multimedia works provided by an embodiment of the present disclosure.

### DETAILED DESCRIPTION

To understand the above objects, features and advantages of the embodiments of the present disclosure more clearly, the scheme of the embodiments of the present disclosure will be further described below. It should be noted that the embodiments of the present disclosure and the features in the embodiments can be combined with each other without conflict.

In the following description, many specific details are set forth in order to fully understand the present disclosure, but embodiments of the present disclosure may be practiced in other ways apart from those described herein; obviously, the embodiments in the specification are only part of the embodiments of the present disclosure, not all of them.

To meet people's demand for diversified interaction methods based on multimedia works, the embodiment of the present disclosure provides an interaction method based on multimedia works. Specifically, when a preset interaction operation triggered for a first multimedia work is received, feedback information corresponding to the first multimedia work is first obtained, and then displayed. The feedback information is used to indicate that a first user obtains a virtual object based on the preset interaction operation.

It can be seen that the embodiment of the present disclosure can respond to the preset interaction operation in a way of displaying feedback information after receiving the preset interaction operation triggered for the first multimedia work, thus enriching interaction modes based on the multimedia work, increasing interest of the interaction based on the multimedia work and improving the user experience.

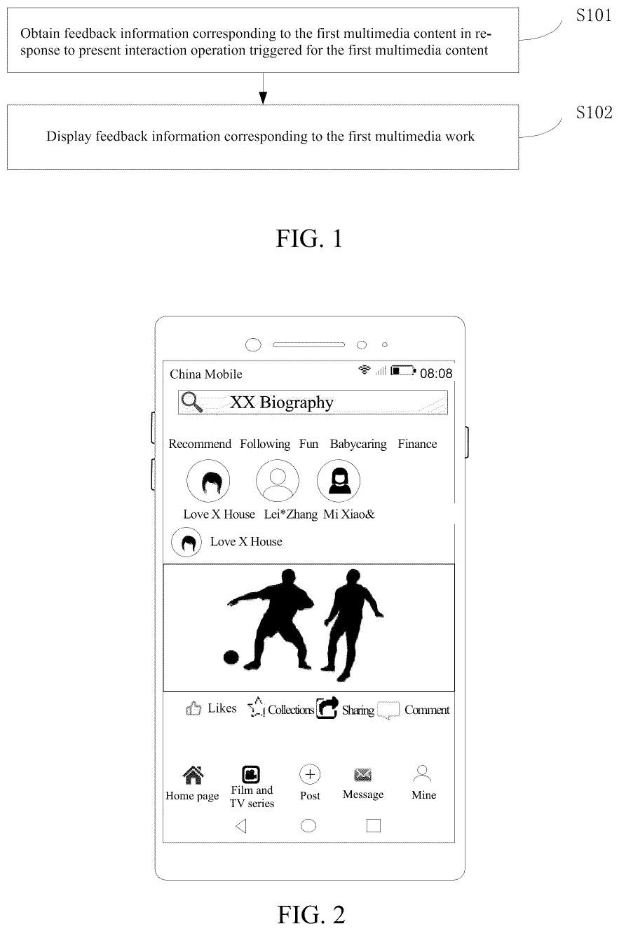

Based on this, an embodiment of the present disclosure provides an interaction method based on multimedia works. Referring to FIG. 1, it is a flowchart of the interaction method based on multimedia works provided by the embodiment of the present disclosure, and the method includes the following steps:

S101: In response to a preset interaction operation triggered for a first multimedia work, the feedback information corresponding to the first multimedia work is obtained.

The feedback information is used to indicate that a first user obtains a virtual object based on the preset interaction operation, and the first user is the creator of the first multimedia work. Step S101 may be to obtain feedback information corresponding to the first multimedia work in response to a preset interaction operation triggered by any user, who may be a viewer of the first multimedia work.

The interaction method based on multimedia works provided by the embodiment of the present disclosure may be applied to a client terminal, and the first multimedia work may be any multimedia work, for example, video work, text work, image work, music work, etc. The preset interaction operation may be any interaction operation that may represent a user's favor for the first multimedia work, in which the user triggers the preset interaction operation. For example, the preset interaction operation may be a positive operation for the first multimedia work, including but not limited to at least one of like operation, long press and like operation, sharing operation, comment operation and collection operation.

Taking the first multimedia work as a video work as an example, as shown in FIG. 2, which is a schematic diagram of the playing page of the first multimedia work provided by the embodiment of the present disclosure. Herein, a like control, a sharing control, a comment control and a collection control are arranged on the playing page (which may be a recommendation page, a following page or a detail page) of the first multimedia work. In the embodiment of the present disclosure, a user (who may be a viewer of the first multimedia work) may trigger a like operation on the first multimedia work by clicking the like control. The long press and like control may trigger the long press and like operation on the first multimedia work, so as to show the user's strong recommendation on the first multimedia work. The sharing operation of the first multimedia work may be triggered by clicking the sharing control. The comment operation on the first multimedia work may be triggered by clicking the comment control. The collection operation of the first multimedia work may be triggered by clicking the collection control.

In addition, the preset interaction operation triggered for the first multimedia work may also be other interaction operations that may represent the user's favor for the first multimedia work, and the embodiment of the present disclosure does not specifically limit the preset interaction operation.

In the embodiment of the present disclosure, when a preset interaction operation triggered for a first multimedia work is received, feedback information corresponding to the first multimedia work is first obtained. The feedback information may indicate that the first user, i.e., the creator of the first multimedia work, obtains the virtual object based on the preset interaction operation. Specifically, virtual objects may include virtual resources, such as virtual costumes, virtual props, virtual skins, virtual money and so on. In addition, virtual objects may also include virtual attributes, such as virtual rank, virtual title and so on.

In an alternative embodiment, the client terminal sends a feedback request to the server when receiving a preset interaction operation triggered for the first multimedia work, wherein the feedback request may carry an identification of the first multimedia work. After receiving the feedback request, the server parses the feedback request to obtain the identification of the first multimedia work, then obtains the feedback information corresponding to the first multimedia work and sends the feedback information to the client terminal. At this point, the client terminal obtains the feedback information corresponding to the first multimedia work from the server.

In an optional embodiment, after receiving the feedback request, the server may trigger an encourage for the creator of the first multimedia work based on preset activity rules, so that the creator of the first multimedia work may obtain virtual objects, such as cash income, red envelope reward, virtual skin, virtual props, etc. After determining the virtual object obtained for the creator of the first multimedia work, the server generates feedback information representing that after the first user obtains the virtual object based on the preset interaction operation, the server returns the feedback information to the client terminal.

S102: the feedback information corresponding to the first multimedia work is displayed.

In the embodiment of the present disclosure, after obtaining the feedback information corresponding to the first multimedia work, the feedback information may be displayed at the client terminal.

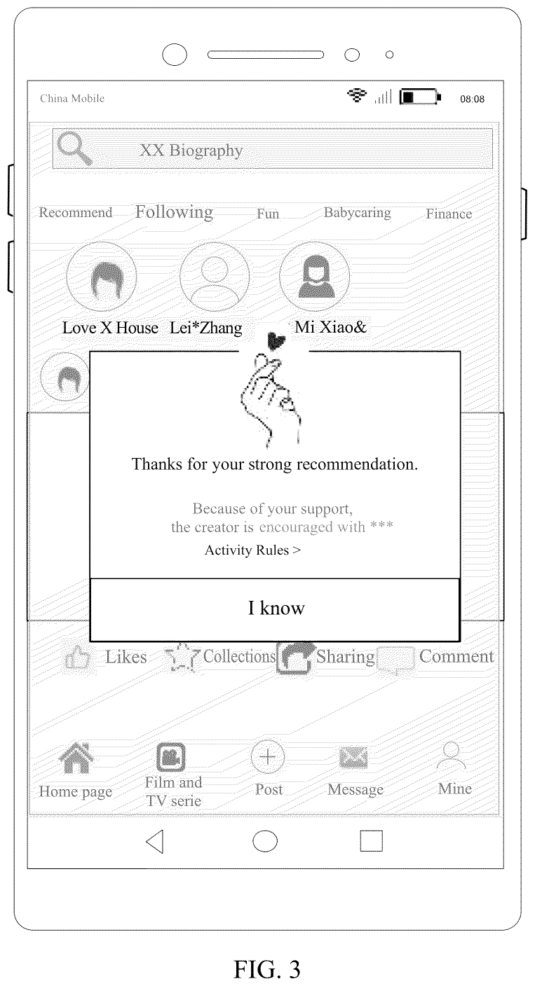

In an alternative embodiment, the feedback information corresponding to the first multimedia work may be displayed on a preset pop-up window. As shown in FIG. 3, which is a schematic diagram of a preset pop-up window provided by an embodiment of the present disclosure, wherein after receiving a preset interaction operation triggered for the first multimedia work, the client terminal displays the preset pop-up window on the playing page of the first multimedia work, and displays the feedback information corresponding to the first multimedia work on the preset pop-up window. As shown in FIG. 3, the feedback information may include words such as “Thanks for your support, the author is encouraged with ***”, which may indicate that the creator of the first multimedia work obtains a virtual object based on the preset interaction operation triggered by the user.

In order to strengthen an interaction cycle based on multimedia works between multimedia works consumers and multimedia works creators, the embodiment of the present disclosure may also give feedback to the creators of the first multimedia works. Specifically, a notification message may be sent to the creator of the first multimedia work to inform the creator that other users have triggered the preset interaction operation for the first multimedia work. For example, the creator is notified that there is a user *** (which may be a user nickname) having triggered a like operation for the first multimedia work, etc.

In the interaction method based on multimedia works provided by the embodiment of the present disclosure, when a preset interaction operation triggered by a first user for a first multimedia work is received, feedback information corresponding to the first multimedia work is first obtained, and then displayed. The feedback information may indicate that the creator of the first multimedia work obtains the virtual object based on the preset interaction operation. The embodiment of the disclosure may respond to the preset interaction operation by displaying feedback information after the first user triggers the preset interaction operation for the first multimedia work, thus enriching the interaction mode based on the multimedia work, increasing the interest of the interaction based on the multimedia work and improving the user experience.

On the basis of the above embodiments, in order to enrich feedback methods for preset interaction operations, when receiving the preset interaction operation triggered for the first multimedia work, the embodiment of the present disclosure not only obtains the feedback information corresponding to the first multimedia work, but also obtains the feedback effect data corresponding to the first multimedia work.

The feedback effect data may include at least one of audio effect data, video effect data and animation effect data. The audio effect data may be a piece of audio effect data recorded by the creator of the first multimedia work. Usually, when a voice of the creator is unique, the creator tends to record a piece of audio effect data as the audio effect data of the video he/she created. In addition, the video effect data may be a distinctive video clip selected by the creator, recorded by the creator personally, or a classic clip of a movie. The animation effect data may be preset with any animation, such as an animation of a thumb-up for likes, an animation of blooming hearts, etc. The embodiment of the present disclosure does not limit the specific content of the feedback effect data.

In a practical application, when a preset interaction operation triggered for a first multimedia work is received, the feedback effect data corresponding to the first multimedia work is obtained, and then played as a response to the preset interaction operation.

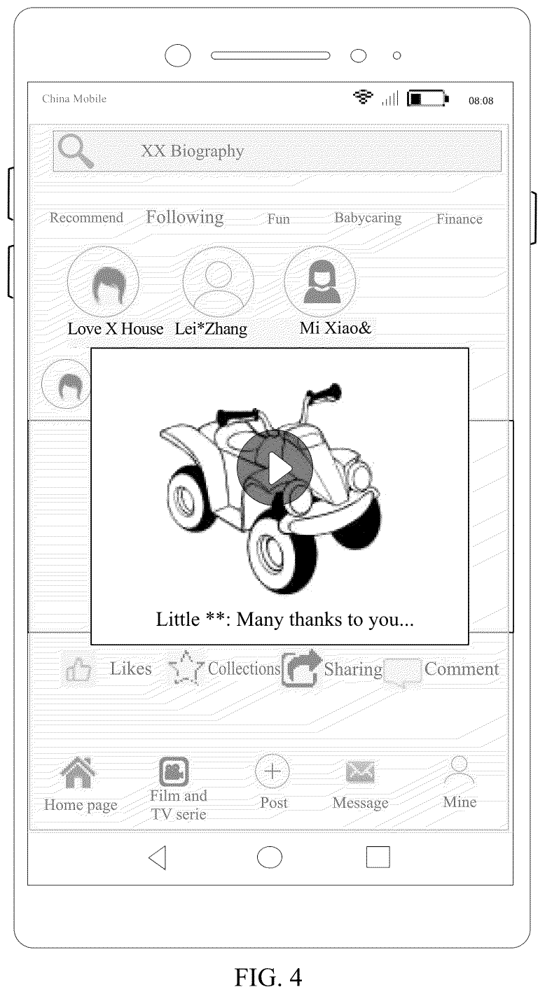

Assuming that the feedback effect data includes video effect data, as shown in FIG. 4, which is a schematic diagram of the playing page of another first multimedia work provided by the embodiment of the present disclosure. When the preset interaction operation triggered for the first multimedia work is received, a mask layer may be displayed on the playing page, and video effect data may be played on the mask layer.

Assuming that the feedback effect data includes audio effect data, when the preset interaction operation triggered for the first multimedia work is received, the audio effect data corresponding to the first multimedia work may be played on the playing page of the first multimedia work.

In an alternative embodiment, since the volume of playing the feedback effect data interferes with the volume of the first multimedia work, the embodiment of the present disclosure may determine the playback volume of the feedback effect data based on the current volume of the first multimedia work before playing the feedback effect data. Specifically, the playback volume of the feedback effect data is greater than the playback volume of the first multimedia work to highlight the volume of the feedback effect data. Then, based on the determined playback volume, the feedback effect data may be played.

It is to be noted that when the first multimedia work is played in a mute state, the feedback effect data may also be played in a mute state.

Assuming that the feedback effect data includes animation effect data, when the preset interaction operation triggered for the first multimedia work is received, the animation effect data corresponding to the first multimedia work may be played on the playing page of the first multimedia work.

In the embodiment of the present disclosure, when the client terminal receives the preset interaction operation for the first multimedia work, it may obtain the feedback effect data corresponding to the first multimedia work from the server. Specifically, the client terminal may send a feedback request to the server, wherein the feedback request carries an identification of the first multimedia work. After receiving the feedback request, the server parses the feedback request to obtain the identification of the first multimedia work, and then obtains the feedback effect data corresponding to the first multimedia work based on the identification.

In an alternative embodiment, the feedback effect data may have a corresponding relationship with the multimedia works. For example, one multimedia work corresponds to one feedback effect data, or multiple multimedia works correspond to one feedback effect data, and the server may directly obtain the corresponding feedback effect data based on the identification of the first multimedia work.

In another alternative embodiment, the feedback effect data may also have a corresponding relationship with the creator, i.e., one creator is configured with one or more feedback effect data, and the server first determines the creator of the first multimedia work based on the identification of the first multimedia work, and then obtains the feedback effect data corresponding to the creator.

In addition, in the embodiment of the present disclosure, the client terminal may load the feedback effect data corresponding to the first multimedia work into a local area in advance when obtaining the first multimedia work, and may obtain the feedback effect data corresponding to the first multimedia work from the local area and play the feedback effect data when receiving the preset interaction operation triggered for the first multimedia work.

In a practical application, the feedback effect data corresponding to the first multimedia work may be pre-configured by the creator of the first multimedia work (hereinafter referred to as a first user). Specifically, a configuration mode of feedback effect data will be introduced in the following embodiments, and will not be described here.

In the video-based interaction method provided by the embodiment of the present disclosure, after receiving the preset interaction operation triggered for the first multimedia work, the preset interaction operation is responded to by displaying feedback information and playing feedback effect data, thus enriching the interaction mode based on the multimedia work, increasing the interest of the interaction based on the multimedia work and improving the user experience.

On the basis of the above embodiments, the embodiment of the present disclosure also provides a configuration method of feedback effect data, which includes the following step:
feedback effect data for a second multimedia work is configured in response to a preset first configuration triggering operation for the second multimedia work.

Herein, the feedback effect data is used to be played when a preset interaction operation is triggered for a second multimedia work, and the second multimedia work may be any multimedia work whose creator is a current user and for which the feedback effect data needs to be configured. Specifically, the second multimedia work may be any multimedia work created by a second user.

In a practical application, after configuring the feedback effect data for the second multimedia work, the corresponding relationship between the feedback effect data and the second multimedia work is uploaded to the server. When the server receives the feedback request corresponding to the second multimedia work from the client terminal, the server may send the feedback effect data corresponding to the second multimedia work to the client terminal, so that the client terminal may respond to the preset interaction operation triggered by the second multimedia work by playing the feedback effect data.

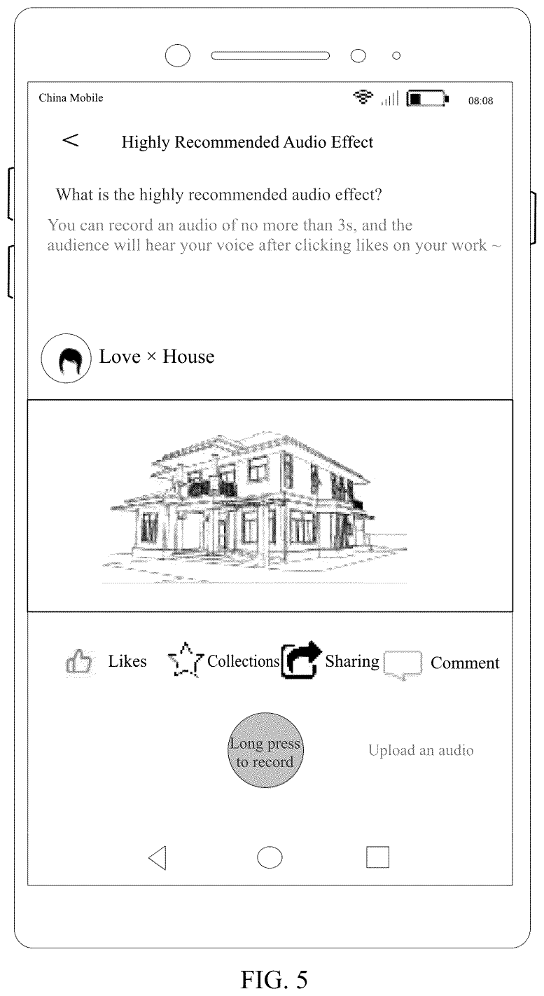

In an alternative embodiment, a first feedback configuration page is displayed in response to a preset first configuration triggering operation for a second multimedia work. FIG. 5 is a schematic diagram of a first feedback configuration page provided by an embodiment of the present disclosure. Herein a recording control and/or an uploading control are arranged on the first feedback configuration page. In response to the triggering operation for the recording control or the uploading control, audio data or video data is recorded or uploaded as the feedback effect data corresponding to the second multimedia work, or an animation is uploaded as the feedback effect data corresponding to the second multimedia work, so as to configure the feedback effect data for the second multimedia work. This embodiment may not only record the feedback effect data in real time, but also directly use the existing data resources to obtain the feedback effect data, which is convenient for interaction and is conducive to quickly meeting the diverse feedback effect data configuration requirements of users.

In addition, the second multimedia work may be played on the first feedback configuration page, so that the user may configure the feedback effect data corresponding to the second multimedia work in the process of playing the second multimedia work.

In an alternative embodiment, after configuring the feedback effect data for the second multimedia work, the second multimedia work configured with the feedback effect data may be previewed, and after the current user triggers the preset interaction operation for the second multimedia work, the feedback effect data configured for the second multimedia work may be played on the preview page to realize the preview of the configuration effect.

In addition, the feedback effect data configured for the second multimedia work may be deleted or modified and so on to adjust the feedback effect data of the second multimedia work.

In this embodiment, by configuring the feedback effect data corresponding to the second multimedia work, the diversity of interaction is improved, and different feedback effect data may be configured for different multimedia works, thereby realizing personalized interaction of different multimedia works and improving user experience.

The embodiment of the present disclosure may not only support the creator to configure the feedback effect data for the multimedia works, i.e., to configure the corresponding relationship between the feedback effect data and the multimedia works. That is to say, different feedback effect data may be configured for different multimedia works with the same user account, and different feedback effect data may be configured for different multimedia works with different user accounts. It may also support the creator to configure the feedback effect data for himself, i.e., to configure the corresponding relationship between the feedback effect data and the user, i.e., to configure the same feedback effect data for one or more different multimedia works of the same user account, thereby enhancing the cognition of the user account.

In a practical application, after configuring the feedback effect data for the second user, the corresponding relationship between the feedback effect data and the second user is uploaded to the server. When the server receives a feedback request from the client terminal for the third multimedia work, the server first determines the creator corresponding to the third multimedia work, assuming that it is the second user. Then the feedback effect data corresponding to the second user is determined and the feedback effect data is sent to the client terminal, so as to respond to the preset interaction operation triggered by the third multimedia work by playing the feedback effect data at the client terminal.

In the embodiment of the present disclosure, the configuring feedback effect data for a user may specifically include the following steps: configuring feedback effect data for a second user in response to a preset second configuration triggering operation for the second user. Herein the feedback effect data is used to be played when the preset interaction operation is triggered for a third multimedia work with the second user as the creator.

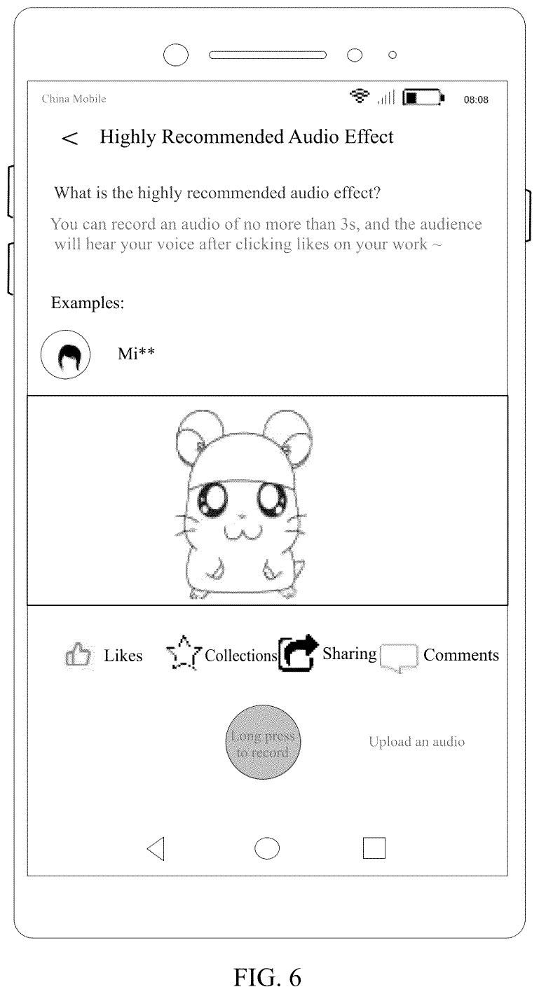

In an alternative embodiment, in response to a preset second configuration triggering operation for the second user, the second feedback configuration page is first displayed. FIG. 6 is a schematic diagram of a second feedback configuration page provided by an embodiment of the present disclosure. Herein the second feedback configuration page is provided with the recording control and/or uploading control. Then, in response to the triggering operation for the recording control or the uploading control, audio data or multimedia work data are recorded or uploaded as the feedback effect data corresponding to the second user, or animation is uploaded as the feedback effect data corresponding to the second user, so as to configure the feedback effect data for the second user.

In an alternative embodiment, an example playing window may be set on the second feedback configuration page. As shown in FIG. 6, the effect of a sample video configured with the feedback effect data is displayed in a sample playing window, such as the effect of triggering the like operation of the sample video to play the feedback effect data, so that the current user may know the effect of the sample video with the feedback effect data.

In an alternative embodiment, the configured feedback effect data may be deleted or modified, thereby facilitating the user to update the feedback effect data. For example, the feedback effect data configured for the second multimedia work may be deleted or modified, and the feedback effect data configured for the second user may also be deleted or modified. Specifically, the feedback effect data is deleted or modified in response to a deletion operation or a modification operation for the feedback effect data configured for the second multimedia work or the second user.

In another alternative embodiment, the fourth multimedia work configured with feedback effect data may also be previewed, and after the preset interaction operation is triggered for the fourth multimedia work, the corresponding feedback effect data may be played to preview the configuration effect of the feedback effect data. For example, after receiving the feedback effect data corresponding to the second user's own account configured by the second user itself for his/her own account, the client terminal may display the corresponding feedback effect data for the second user to view when the client terminal receives the preset interaction operation for the multimedia works posted by the second user. Alternatively, after the client terminal receives the feedback effect data configured for the second multimedia work, the client terminal displays the corresponding feedback effect data for the second user to view when the client terminal receives the preset interaction operation for the second multimedia work triggered by the second user. Of course, it is not limited to this.

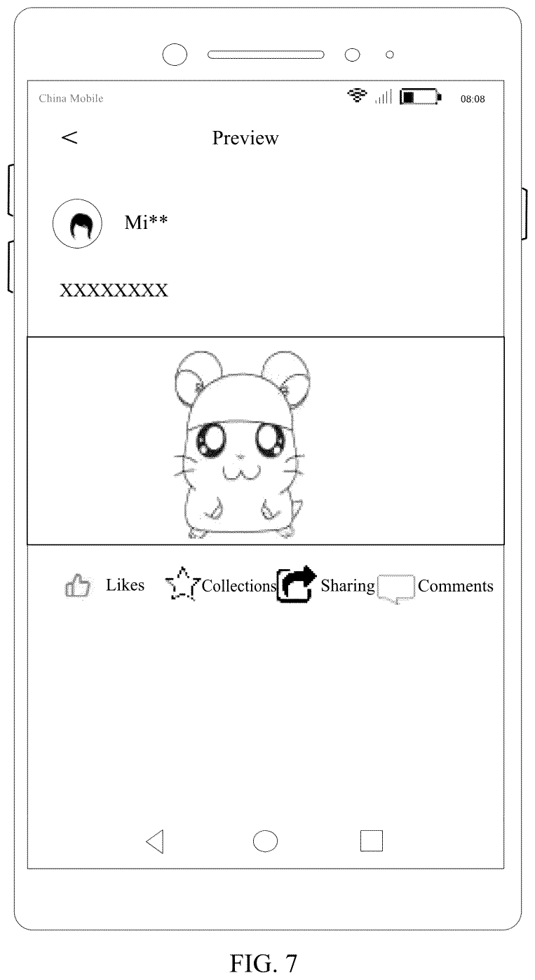

Specifically, first, the fourth multimedia work is played on the preview page. Refer to FIG. 7, which is a schematic diagram of a preview page provided by an embodiment of the present disclosure. In response to the preset interaction operation triggered for the fourth multimedia work, the feedback effect data configured for the second user is played on the preview page to realize the preview of the configuration effect.

In addition, in order to strengthen the interaction cycle based on multimedia works between multimedia works consumers and multimedia works creators, the creators of multimedia works may also receive notification messages for the creators of the multimedia work, so as to inform the creators that other users have triggered preset interaction operations for a certain multimedia work.

Specifically, the client terminal of the creator receives the notification message for the second multimedia work or the third multimedia work; herein, the notification message is used for instructing the third user to trigger the preset interaction operation for the second multimedia work or the third multimedia work.

It is to be noted that the first multimedia work, the second multimedia work, the third multimedia work and the fourth multimedia work in the above embodiments may be the same multimedia work or different multimedia works, and the first user, the second user and the third user may be the same user or different users.

The interaction method based on multimedia works provided by the embodiment of the present disclosure provides an interactive function for the creator to configure the feedback effect data, further enriches the interaction mode based on multimedia works, and improves the user experience.

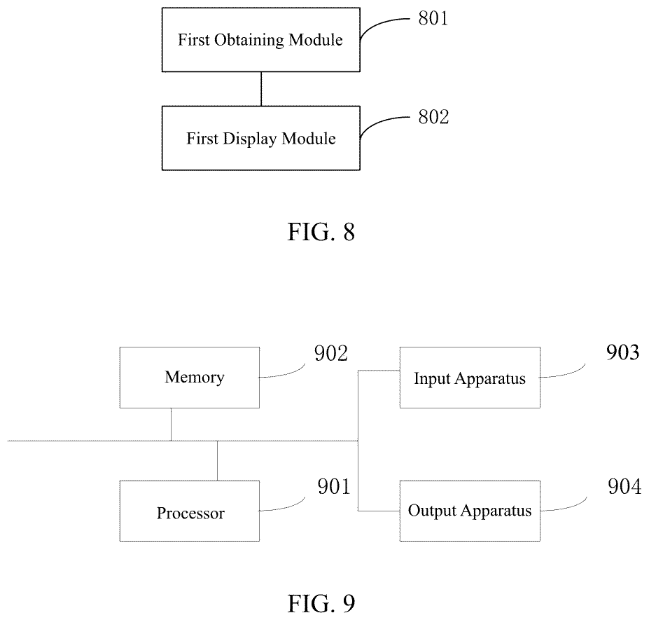

Based on the same inventive concept as the above method embodiment, the present disclosure also provides an interaction apparatus based on multimedia works. Referring to FIG. 8, it is a structural schematic diagram of the interaction apparatus based on multimedia works provided by the embodiment of the present disclosure, and the apparatus includes:
a first obtaining module 801, configured to obtain feedback information corresponding to a first multimedia work in response to a preset interaction operation triggered for the first multimedia work; wherein the feedback information is used to indicate that a first user obtains a virtual object based on the preset interaction operation, and the first user is the creator of the first multimedia work; and
a first display module 802, configured to display the feedback information corresponding to the first multimedia work.

In an alternative embodiment, the display module is specifically used for:
displaying the feedback information corresponding to the first multimedia work on a pop-up window.

In an alternative embodiment, the apparatus further comprises:
a second obtaining module, configured to obtain the feedback effect data corresponding to the first multimedia work in response to the preset interaction operation triggered for the first multimedia work; herein the feedback effect data includes at least one of audio effect data, video effect data and animation effect data; and
a first playing module, configured to play the feedback effect data.

In an alternative embodiment, the first multimedia work is a video work or a music work, and the first playing module comprises:
a first determining submodule, configured to determine a playback volume of the feedback effect data based on a current volume of the first multimedia work; wherein the playback volume is greater than the current volume of the first multimedia work; and
a first playing submodule, configured to play the feedback effect data based on the playing volume.

In an alternative embodiment, the apparatus further comprises:

A first configuration module, configured to configure feedback effect data for a second multimedia work in response to a preset first configuration triggering operation for the second multimedia work; wherein the feedback effect data is used to be played when the preset interaction operation is triggered for the second multimedia work.

In an alternative embodiment, the first configuration module comprises:
a first display sub-module, configured to display a first feedback configuration page in response to a preset first configuration triggering operation for a second multimedia work, wherein a recording control and/or an uploading control are arranged on the first feedback configuration page; and
a first recording/uploading sub-module, configured to, in response to a triggering operation for the recording control or the uploading control, record or upload audio data or video data as feedback effect data corresponding to the second multimedia work or upload an animation as feedback effect data corresponding to the second multimedia work.

In an alternative embodiment, the apparatus further comprises:
a second configuration module, used to configure the feedback effect data for the second user in response to the second configuration triggering operation; wherein the feedback effect data is used to be played when the preset interaction operation is triggered for a third multimedia work with the second user as the creator.

In an alternative embodiment, the second configuration module comprises:
a second display sub-module, configured to display a second feedback configuration page in response to a preset second configuration triggering operation for a second user, wherein recording control and/or an uploading control are arranged on the second feedback configuration page; and
a second recording/uploading sub-module, configured to, in response to a triggering operation for the recording control or the uploading control, record or upload audio data or video data as feedback effect data corresponding to the second user or upload an animation as feedback effect data corresponding to the second user.

In an alternative embodiment, the apparatus further comprises:
a deletion/modification module, configured to delete or modify the feedback effect data in response to a deletion operation or a modification operation for the configured feedback effect data.

In an alternative embodiment, the apparatus further comprises:
a first receiving module, configured to receive a notification message for the second multimedia work; wherein, the notification message is used for instructing the third user to trigger the preset interaction operation for the second multimedia work.

In an alternative embodiment, the apparatus further comprises:
a second receiving module, configured to receive a notification message for the third multimedia work; wherein, the notification message is used for instructing a third user to trigger the preset interaction operation for the third multimedia work.

In an alternative embodiment, the apparatus further comprises:
a third playing module, configured to play the fourth multimedia work on the preview page; and
a fourth playing module, configured to play the feedback effect data on the preview page in response to the preset interaction operation triggered for the fourth multimedia work.

In the interaction apparatus based on multimedia works provided by the embodiment of the present disclosure, when a preset interaction operation triggered by a first user for a first multimedia work is received, feedback information corresponding to the first multimedia work is first obtained, and then displayed. The feedback information may indicate that the creator of the first multimedia work obtains the virtual object based on the preset interaction operation. The embodiment of that disclosure may respond to the preset interaction operation by displaying feedback information after receiving the preset interaction operation triggered for the first multimedia work, thereby enriching the interaction modes base on the multimedia work, increasing the interest of the interaction based on the multimedia work and improving the user experience.

In addition to the above methods and apparatuses, the embodiment of the present disclosure also provides a computer-readable storage medium in which instructions are stored, which, when run on a terminal device, enable the terminal device to realize the interaction method based on multimedia works described in the embodiment of the present disclosure.

The embodiment of the present disclosure also provides a computer program product, including computer programs/instructions, wherein when the computer programs/instructions are executed by a processor, the interaction method based on multimedia works described in the embodiment of the present disclosure is realized.

In addition, the embodiment of the present disclosure also provides an interaction device based on multimedia works, as shown in FIG. 9, which may include:

A processor 901, a memory 902, an input apparatus 903 and an output apparatus 904. A number of processors 901 in an interaction device based on multimedia works may be one or more, and one processor is taken as an example in FIG. 9. In some embodiments of the present disclosure, the processor 901, the memory 902, the input apparatus 903 and the output apparatus 904 may be connected by a bus or other means, herein the connection by a bus is taken as an example in FIG. 9.

The memory 902 may be used to store software programs and modules, and the processor 901 executes various functional applications and data processing of interaction devices based on multimedia works by running the software programs and modules stored in the memory 902. The memory 902 may mainly include a storage program area and a storage data area, wherein the storage program area may store an operating system, application programs required by at least one function, and the like. In addition, the memory 902 may include high-speed random access memory and non-volatile memory, such as at least one disk memory device, flash memory device, or other volatile solid-state memory devices. The input apparatus 903 may be used to receive input digital or character information and generate signal input related to user setting and functional control of an interaction device based on a multimedia work.

Specifically, in this embodiment, the processor 901 will load executable files corresponding to the processes of one or more application programs into the memory 902 according to the following instructions, and the processor 901 will run the application programs stored in the memory 902, thus realizing various functions of the interaction device based on multimedia works.

It should be noted that in this paper, relational terms such as “first” and “second” are only used to distinguish one entity or operation from another entity or operation, and do not necessarily require or imply that there is any such actual relationship or order between these entities or operations. Moreover, the terms “including”, “comprising” or any other variation thereof are intended to cover non-exclusive inclusion, so that a process, method, article or device including a series of elements includes not only those elements, but also other elements not explicitly listed or elements inherent to such a process, method, article or device. Without further restrictions, an element defined by the phrase “including one” does not exclude the existence of other identical elements in the process, method, article or device including the element.

What has been described above is only the specific embodiment of the present disclosure, so that those skilled in the art can understand or realize the present disclosure. Many modifications to these embodiments will be obvious to those skilled in the art, and the general principles defined herein can be implemented in other embodiments without departing from the spirit or scope of this disclosure. Therefore, this disclosure will not be limited to the embodiments described herein, but is to be accorded the widest scope consistent with the principles and novel features disclosed herein.

What is claimed is:

1. An interaction method based on multimedia contents, comprising:
obtaining feedback information corresponding to a first multimedia work in response to a preset interaction operation triggered for the first multimedia content; wherein the feedback information is used to indicate that a first user obtains a virtual object based on the preset interaction operation, and the first user is a creator of the first multimedia content; and
displaying the feedback information corresponding to the first multimedia content. N (Currently amended) The method according to claim 1, wherein the displaying the feedback information corresponding to the first multimedia content comprises:
displaying the feedback information corresponding to the first multimedia content on a pop-up window.

3. The method according to claim 1, further comprising:
obtaining feedback effect data corresponding to the first multimedia content in response to the preset interaction operation triggered for the first multimedia content; wherein the feedback effect data includes at least one of audio effect data, video effect data and animation effect data; and
playing the feedback effect data.

4. The method according to claim 3, wherein the first multimedia work is a video content or a music content, and the playing the feedback effect data comprises:
determining playback volume of the feedback effect data based on current volume of the first multimedia content; wherein the playback volume is greater than the current volume of the first multimedia content; and
playing the feedback effect data based on the playing volume.

5. The method according to claim 3, further comprising:
configuring feedback effect data corresponding to a second multimedia content in response to a first configuration triggering operation for the second multimedia content; wherein the feedback effect data is used to be played when the preset interaction operation is triggered for the second multimedia content.

6. The method according to claim 5, wherein the configuring the feedback effect data corresponding to the second multimedia content in response to the first configuration triggering operation for the second multimedia content comprises:
displaying a first feedback configuration page in response to a first configuration triggering operation for a second multimedia content, wherein a recording control and/or an uploading control are arranged on the first feedback configuration page; and
recording or uploading audio data or video data as the feedback effect data corresponding to the second multimedia content in response to the triggering operation for the recording control or the uploading control, or uploading an animation as the feedback effect data corresponding to the second multimedia content.

7. The method according to claim 3, further comprising:
configuring feedback effect data corresponding to a second user in response to a second configuration triggering operation; wherein the feedback effect data is used to be played when the preset interaction operation is triggered for a third multimedia content with the second user as the creator.

8. The method according to claim 7, wherein the configuring the feedback effect data corresponding to the second user in response to the second configuration triggering operation comprises:
displaying a second feedback configuration page in response to the second configuration triggering operation, wherein the recording control and/or the uploading control are arranged on the second feedback configuration page; and
recording or uploading audio data or video data as the feedback effect data corresponding to the second user in response to the triggering operation for the recording control or the uploading control, or uploading an animation as the feedback effect data corresponding to the second user.

9. The method according to claim 5, further comprising:
deleting or modifying the feedback effect data in response to a deleting operation or a modifying operation for the configured feedback effect data.

10. The method of claim 5, further comprising:
receiving a notification message for the second multimedia content; wherein, the notification message is used for instructing a third user to trigger the preset interaction operation for the second multimedia content.

11. The method according to claim 7, further comprising:
receiving a notification message for the third multimedia content; wherein, the notification message is used for instructing the third user to trigger the preset interaction operation for the third multimedia content.

12. The method according to claim 5, wherein after the configuration of the feedback effect data is completed, the method further comprises:
playing a fourth multimedia content on a preview page; and
playing the feedback effect data on the preview page in response to the preset interaction operation triggered for the fourth multimedia content.

13. (canceled)

14. (canceled)

15. A device, comprising: a memory, a processor, and a computer program stored in the memory and executable on the processor, wherein when the processor executes the computer program, the interaction method based on multimedia contents comprising:
obtaining feedback information corresponding to a first multimedia content in response to a preset interaction operation triggered for the first multimedia content; wherein the feedback information is used to indicate that a first user obtains a virtual object based on the preset interaction operation, and the first user is a creator of the first multimedia content; and
displaying the feedback information corresponding to the first multimedia content.

16. A computer program product, comprising computer programs/instructions which, when executed by a processor, realize the interaction method based on multimedia contents comprising:
obtaining feedback information corresponding to a first multimedia content in response to a preset interaction operation triggered for the first multimedia content; wherein the feedback information is used to indicate that a first user obtains a virtual object based on the preset interaction operation, and the first user is a creator of the first multimedia content; and
displaying the feedback information corresponding to the first multimedia content.
